(19) United States
(12) Patent Application Publication
(10) Pub. No.: US 2011/0066379 A1
(43) Pub. Date: Mar. 17, 2011

(54) SURVEY SYSTEM FOR LOCATING GEOPHYSICAL ANOMALIES

(76) Inventor: Marius J. Mes, Texas, TX (US)

(21) Appl. No.: 12/994,358

(22) PCT Filed: May 15, 2009
(86) PCT No.: PCT/NO09/00186

§ 371 Date: Nov. 23, 2010

(30) Foreign Application Priority Data
May 26, 2008 (NO) 20082385

(51) Int. Cl. G01V 3/08; G06F 19/00; G01V 3/165

(52) U.S. Cl. 702/6; 702/85

(57) ABSTRACT

A survey system is described for locating and classifying geophysical anomalies. It includes a moving platform equipped with a recording unit for recording the position of the platform. The system also comprises three first measuring units or sensors, adapted to record a varying electric field strength and a varying magnetic field strength at chosen intervals and thus positions, said first measuring units being adapted to measure said field strengths in three independent and mutually orthogonal directions at frequencies in a chosen range. The system includes a calculation unit for combining the measurements from each of said first sensors and calculating and recording as well as comparing the field strength vectors of the varying measured fields at each position, to find anomalies.

### FIELD OF THE INVENTION

A survey system is presented for locating geophysical anomalies by passively measuring natural variations in electric and magnetic field strengths. Such anomalies are sometimes associated with natural resources. The collected measurements are processed and interpreted for the presence of anomalies. If anomalies are found, their location, extent nature and depth are derived.

### BACKGROUND OF THE INVENTION

The well-known Schumann Resonance phenomena of the ionosphere produce clearly discernable electromagnetic waves. The Schumann Resonance frequencies of interest are 7.8, 14.3, 20.8, 27.3 and 33.8±1.0 Hz with a spectral band width of approximately 20%. Their peak strength usually is at around 10, 16 and 22 hours GMT. Our measurements are energized by the electromagnetic energy of the Schumann resonances as well as the energy of the so-called 1/f noise of electromagnetic waves with frequencies around one Hertz and below. The observable strength of these electromagnetic waves will include variations because of leakage into the earth at a rate that will vary as a function of local geophysical properties. They can be received on, in or above the surface of the earth or in the sea waters. These modified electric (E-type) and magnetic (B-type) emissions (the signal we are interested in) are very small when compared to the other electromagnetic signals (which are considered to be noise). This invention is used to locate geophysical anomalies by determining where electromagnetic waves are potentially modified by geophysical anomalies.

### PRIOR ART

A description of prior art can be found in many patent applications. Examples of publications representing the known art are:

1) U.S. Pat. No. 7,002,349/U.S. Pat. No. 7,002,350
2) U.S. Pat. No. 4,792,761
3) U.S. Pat. No. 4,286,218

### 4) WO_{—}2007018810

### 5) US H1490 A

6) U.S. Pat. No. 4,617,518
7) U.S. Pat. No. 7,126,338
8) U.S. Pat. No. 5,777,476
9) U.S. Pat. No. 6,937,190
10) U.S. Pat. No. 6,876,202

Of the publications mentioned above U.S. Pat. No. 7,002,349 describes a system using 3D electric field sensors, but only one total (not 3D) magnetic field sensor that cannot measure magnetic variations above 5 Hz accurately in 3D as required in my invention. In addition, these patents by Barringer rely on curved plate antennas for their 3D electric sensors that do not exhibit orthogonally independent characteristics and thus cannot be used to derive the relative magnitude and direction of the E vector on which my invention relies. U.S. Pat. No. 4,792,761, U.S. Pat. No. 4,286,218 and WO2007018810 describe systems where the measurements are performed with stationary platforms. US H1490, U.S. Pat. No. 4,617,518, U.S. Pat. No. 7,126,338 and U.S. Pat. No. 5,777,476 all concern active systems generating electromagnetic waves to be received by sensors.

### BRIEF SUMMARY OF THE INVENTION

The purpose of the invention is to recognize the presence of anomalous volumes of material, their nature, depth, geographical location and extent below the surface of the earth by passively detecting relative differences in the natural electric (E-type) and magnetic (B-type) emissions in three dimensions; more specifically the field strengths are measured by a 3D sensor system that moves in a survey area of interest on or over land or above, on, or under water. This is achieved through recognizing relative differences in signal characteristics of continuous measurements in a survey grid. More specifically the objects stated above are obtained by a system and method characterized as stated in the accompanying independent claims.

The invention will be discussed more in detail with reference to the accompanying drawings, which illustrate the invention by way of example.

FIG. 1 illustrates a survey device according to an embodiment of the invention.

FIG. 2 illustrates a schematic circuit for the system according to the invention.

FIG. 3 illustrates a method for obtaining the measurements according to the invention.

FIG. 4 illustrates a waterfall plot used according to the invention for locating the geological anomalies.

FIG. 5 illustrates a plot of one cycle of an electric (E-type) and magnetic (B-type) emission at a certain frequency for a certain data segment showing their relative phase, magnitude and angle.

### BRIEF DESCRIPTION OF THE SEVERAL VIEWS OF THE DRAWINGS

FIG. 1 illustrates a purpose-built survey device (a drone 1) adapted for towing in air by a cable 2. Alternatively other devices may be used to carry all or part of the electronic survey equipment, such as, but not limited to, a stinger of an aircraft. The equipment in the drone and the equipment in the airplane towing the drone comprise all electronic components needed to receive electric and magnetic vibration signals, heading, speed, geographical information, temperature and still pictorial information of the area under the plane. A power supply is included to operate the equipment. The sensor data are conditioned, digitized, and stored locally or transmitted to a suitable data storage system. The body of the survey device is made of a non-conducting and non-magnetic material so that it does not disturb the measurements. As depicted, three mutually orthogonal antennas 3 (E-type sensors) of approximately one meter long are mounted on the drone, thus providing a 3D measuring system. In order to give optimized measurements they preferably have mutually independent orthogonal response characteristics. One antenna may be placed inside the drone; the other two may be contained inside wing-like structures 4. Where and how these antennas are placed on or in the drone is not significant; it is critical, however, that the three antennas are mutually orthogonal to one another. Curved rod or plate antennas are excluded in the preferred embodiment of the invention because they do not have independent orthogonal response characteristics.

Three mutually orthogonal magnetic field strength sensors (B-type sensors) 5 are placed in the drone. They must according to the preferred embodiment of the invention have mutually independent orthogonal response characteristics. Their orientation with respect to the antennas is fixed. An electronics package 6 is included inside the drone. A Global Positioning System (GPS) 7 is used to provide geographical position data, speed, and heading of the survey device. This GPS system may be placed elsewhere, such as, but not limited to, the airplane towing the drone, as survey location accuracy permits. A stabilizing tail fin 8 may be used to facilitate handling of the drone while in flight.

A time tagged still pictorial record of the survey area under the plane is recorded by one or several still cameras 9.

FIG. 2 depicts a generalized electric circuit diagram of the E-type and B-type receivers and a temperature measurement system. Each sensor connects to its own electronic circuit. There are three E-type receivers, three B-type receivers, and one temperature measurement system. An E-type receiver has a generic rod, dipole (these may be telescoping) or plate type antenna 100 as a sensor to measure the electric field strength data. A B-type receiver has a magnetic field strength sensor 101 to obtain magnetic field strength measurements. A temperature sensitive resistor 102 is used as a sensor to measure temperatures. To confirm the calibration of the instruments, calibration devices 103 are used to automatically supply signals of known characteristics to the amplifiers (instead of signals from the sensors) before and after each survey. The signals from each of these sensors are typically coupled to and amplified by an amplifier 110, filtered by a low pass filter 120, and then digitized by an Analog to Digital (AD) converter 130. The sampling rate of the data is chosen to provide a suitable representation of the analog signals over the frequency range of interest. A voice channel 160 may also be included in the digitized data. From the AD-converter 130 the digital signals are communicated by wire, glass fiber or a wireless communication device 140 to a data recording device 150 such as, but not limited to, one or more laptop computer(s). Photographic signals 180 are also recorded on a data recording device. Position data from the GPS receiver 170 are also coupled to the system and incorporated in the digital signals.

FIG. 3 illustrates the generalized data interpretation procedure based on the preferred embodiment of the invention where both E- and B-type signals are used, as well as the phase and angle between them. The digital data represent the continuous signals recorded for the survey duration from three independent and mutually orthogonal E-type and three independent and mutually orthogonal B-type (Electric and Magnetic Field Strength data Eₓ(t), E_{y}(t), E_{Z}(t) and Bₓ(t), B_{y}(t), B_{z}(t)) receiving systems and temperature (T(t)) as well as geographical position, speed and heading data 200 from temperature sensors and a positioning system such as GPS. These signals are recorded in digitized form as a function of the time “t”.

The E- and B-type signals may be corrected for temperature sensitivity and calibration differences of the electronic sensor and receiver system as well as the electromagnetic signature of the survey device as necessary 210. The corrected data are treated as a summation of wave sinusoids. Their processing is based on oscillatory components contained in the data; their average values are ignored. The data records are split into N data segments of equal length (and duration) with k data points each. Data for each sensor may be detrended. Overlapping or non-overlapping data segments may be chosen. The geographical location referencing the middle of the data segment is the geographical location reference for that segment. The data in each record segment is treated as a summation of wave sinusoids. A Fast Fourier Transform (FFT) or similar 220 is performed on the E- and B-type data for all N data segments Eₓ(n, f), Bₓ(n, f), E_{y}(n, f), B_{y}(n, f), E_{z}(n, f), B_{z}(n, f) with 1<n<=N and 0<f<=k/2−1. The RMS value of data in each data segment may be computed and the slopes found in the detrending analysis may be retained for evaluation. In FIG. 3 “n” is used for the n^{th} data segment while “f” represents the frequency of a particular component identified by the FFT analysis. Additional parameters may be derived for additional interpretations such as the angle α(n,f) and phase Ø(n,f), such as pictorially indicated in FIG. 5, between the E(n,f) and B(n,f) vectors, the E(n,f) and B(n,f) moduli, certain ratios, and other values 230 which may be derived from these parameters. A Parzen type filter is used to select specific information of selected frequencies for further analysis.

So-called waterfall spectrum plots as illustrated in FIG. 4 showing the frequency (f) vs. position (P) are used in the visual interpretation process for the chosen range of frequencies 240 to identify the areas where differences in equivalent properties of certain variables occur from segment to segment. Generally in the visual analysis, the strength of a signal at a particular frequency at a particular segment is represented by a color. Relative differences of the colors at frequencies for different segments could hint at the presence of a geophysical anomaly. For example, the frequency marked (a) in FIG. 4 could indicate the presence of noise at that frequency because it is observed at all locations. The relative differences in color for different segments observed in area (b) of FIG. 4 could indicate the presence of an anomaly if the difference is above a chosen threshold. The determination if a signal anomaly could relate to a geophysical anomaly includes an inspection with a still or video camera of the pictorial survey record to see if man-made objects (such as, but not limited to railways and ships) could be the cause of the anomalous measurements. This selection process is intended to increase the signal-to-noise ratio of useful information relating to geophysical anomalies.

Other methods for automatically interpreting the data may be used based on a number of alternative analysis algorithms such as, but not limited to, multivariate analysis and magnetovariational techniques. The chosen threshold may depend on the application and may also be determined in the algorithms used for analyzing the signal, thus making it possible to detect areas where the parameters relating to a specific area differ significantly from surrounding parameters sampled by the same kind of measurements and analysis.

After data anomalies are identified, the geographical extent, depth and nature of the associated geophysical anomalies are derived from differences at selected frequencies 250.

The analysis process is intended to increase the signal-to-noise ratio of useful information relating to geophysical anomalies. The interpretation results may call for an optimization of the analysis parameters, such as the segment length and frequency resolution, in which case part of the analysis is repeated 260 until optimal analysis results are obtained. The final steps in the data analysis and interpretation are to prepare certain combinations of function values at certain frequencies for mapping purposes and relate the interpretation results to a map coordinate system 270 and map the results. It is to be expressly understood that the description and drawings are only for the purpose of illustration and as an aid to understanding, and are not intended as a definition of the limits of the invention.

### DETAILED DESCRIPTION

The E- and B-type vibratory signals that are influenced by a deep anomalous volume of rock will be a minute part of the total signal received. The deeper the anomalous volume is located, the smaller signal-to-noise ratio one can expect for the signals of interest. The presence of electrically conducting media and other media that attenuate E- and B-type signals above an anomaly such as, but not limited to, salt water in the geological matrix as well as sea water offshore will further reduce the strength of the signals from the anomaly.

Instruments to receive electric and/or magnetic vibratory signals may be placed on specially equipped moving devices such as, but not limited to, cars, ships, submarines, airplanes, and drones.

Both the E-type and the B-type field strengths vary seemingly independently with time and location. This means that it is not possible to correct field measurements accurately with data from a distant reference station. It also means that the reference strength of the signals along a survey line is not the same as at the survey location. Also, the time at which changes occur varies along the survey. For this reason our interpretation depends on the dimensionless ratio of E- and B-type measurements and the angle between the E- and B-vectors which are independent of the field strength at the reference station. This causes that no measurements from a stationary or fixed reference station are needed in the application of this invention.

It is known that E- and B-type vibratory signals are sensitive to the elevation above the earth's surface. This elevation should be the same within close tolerances for measurements throughout the survey area. Corrections to data should be made using known principles if variations over a few meters are observed.

Noise in the data is influenced by the height of the survey device moving over the earth. The further away from an anomaly the receivers are, the more irrelevant the signals are which are received from surrounding volumes of material at a larger radius from the survey location. Therefore the survey should take place as close as practical to the surface of the earth on land and as close as possible to the sea surface offshore for surface measurements and as close to the seabed as possible for underwater measurements in order to obtain data with the highest signal-to-noise ratio.

Data collection and interpretation procedures must be rationally integrated into consistent operations that result in a geographical map or maps showing the areas of interest. Survey lines are planned. The survey device with the sensors is moved along each survey line to collect continuous data along each line. Each survey line may take from seconds to hours to survey depending on the survey speed and the distance covered. For each line the continuous data is digitized and stored as a digital record representing the continuous survey results together with GPS geographical position reference, heading and temperature data.

A key for this invention to be successful is the use of a magnetic sensor with a resolution in the pico Tesla range, preferably better than 100 pico Tesla, combined with the ability to sample the magnetic field strength with a frequency of several thousand Hertz. Only then is it possible to apply frequency based interpretations to locate anomalies with any degree of accuracy. These sensors were recently invented by Micromem Applied Sensor Technology Inc. Their invention concerns a Hall sensor based on GaAs substrate. Alternatively a cesium magnetometer may be used for obtaining resolutions in the mentioned range or magnetoresistant sensors that allow sampling at a high rate, which may require a higher amplification. For the electric field strength measurements equivalent capabilities are commonly available.

Measurements with these devices are not significantly influenced by magnetic induction caused by changes in the movement of the survey device.

Heading and attitude changes will lead to changes in the signals measured by the three mutually orthogonally placed E- and B-type sensors. However the instantaneous modulus of the E- and B-type vectors as well as the angle between them is independent of the heading, speed and attitude of the survey device. Therefore, according to the present invention, the interpretation of the data is based on the modulus (magnitude) of the electric and the magnetic field strength vectors as well as the angle and phase between them. No corrections to the data for changes in heading, speed and attitude are necessary and thus no survey platform attitude sensor is needed.

The minimum duration and the rate of digitization for which the E- and/or B-type vibration (oscillatory) signal data are collected vary as a function of the local circumstances and survey parameters. The duration depends on the accuracy required to analyze the lowest frequency of interest contained in the data record and also on the acceptable minimum spatial resolution of the interpretations. The latter also depends on the speed of propagation of the survey platform. The minimum rate of digitization generally depends on the signal strength of the highest frequency present in the signal before digitization as well as the resolution of the rate of digitization.

An E-field receiver is used to record electric oscillatory field strength data using a generic antenna with a length of approximately a meter such as, but not limited to, a wire, a telescoping rod, a dipole antenna or a single and/or dipole flat plate antenna. This present invention relies on three E-field receivers with independent and mutually orthogonal antennas.

A B-field receiver is used to record measurements of magnetic oscillatory field strength data using magnetic field strength sensors, and according to the present invention, three B-field receivers are required with independent and mutually orthogonal sensors.

A temperature sensor is used to collect temperature data of the receiver systems. Known signals are supplied to the receiver systems before and after the survey for calibration purposes.

Data from each sensor is individually amplified, and frequencies outside the range of interest are removed by electronic filtering before digitization and then digitized. The digitized data that represent the continuous signals are transmitted and stored on a suitable medium for interpretation.

A GPS receiver is used to record geographical position data of the positions where the E- and B-type data are collected. The data processing generally follows the steps as outlined in FIG. 3.

The data contained in each segment will represent the data collected over a certain distance. Each data segment will result in one interpretation that is considered representative for that segment. The distance traveled by the survey device to collect the data in such segment is a measure for the resolution of the interpretation. An additional N−1 overlapping data segment may be obtained (for increased survey spatial resolution) by shifting the start of these data segments by an integer k/2 data points (not depicted). Successive interpretations will be correlated to some degree. Commonly, data segments are used that overlap 50% of each of the bordering data segments.

The geographical extent, depth and nature of a suspected anomaly is derived from a comparison of data such as, but not limited to, α(n,f), Ø(n,f), ratios of functions of E(n,f) to functions of B(n,f) and other derived function values with one another for certain frequencies for nearby data segments.

The estimated depth of a suspected anomaly is derived from the different rates of attenuation as compared to the expected rate of attenuation for the different frequencies using Maxwell's equations. The accuracy of the estimated depth depends on the accuracy of (estimated) geophysical input properties to Maxwell's equation.

An indication of the type of material in the anomaly is based on differences in electric and magnetic properties of the anomaly. These differences result typically in variations of α(n,f), Ø(n,f) and ratios of functions of E(n,f) to functions of B(n,f) and other derived function values for certain frequencies. These variations are indicative of changes in resistivity and conductivity in the formation profile. They can readily be recognized by an experienced interpreter who is familiar with local conditions.

Data representing anomalous signals and their geographical locations are mapped for further correlation with other geographical, geological, or geophysical information in search of the presence and location of possible resources or other information of interest.

All of the features described in this document are illustrative in nature; modifications and/or improvements will likely be made. Accordingly, this patent is limited only as defined in the appended claims.

The invention represents an integrated data collection and interrelated sensor dependent data interpretation survey system for locating geophysical anomalies from naturally occurring electric and magnetic field strength oscillations.

The data collection hardware includes, but is not limited to:
a) A survey device equipped with sensor systems intended to move in an area of interest along survey lines on or above land or above, below, or on the sea surface;
b) The use of said sensor systems to measure both the naturally occurring electric and magnetic oscillatory field strengths' oscillations as three dimensional vectors with three independent and mutually orthogonal sensor systems for each that are fixed with respect to one another, providing six channels of data;
c) Additional sensor systems for the measurement of the temperature of the sensors;
d) A system to automatically provide calibration signals of known characteristics to the sensors before and after the collection of survey data for data validation and calibration purposes;
e) The use of additional sensor systems to include time, heading, survey speed, and geographical location information of said survey device;
f) The digitization of data from said sensor systems to obtain digitized data that represent these data;
g) A system to make a digital time and geographical location tagged still pictorial record of the survey area;
h) Transmission of said digitized data to a suitable storage medium and storage of said digitized data for interpretation.
The sensor-dependent and integrated data processing and interpretation method includes:
a) Validating said digitized data by confirming the sensor calibration using said calibration data;
b) Correcting said digitized data for temperature variations during the survey to compensate for the temperature sensitivity of the electronic systems as well as residual magnetic and electric fields associated with the survey device;
c) Correcting said digitized data for variations in the elevation of the survey device during the survey to compensate for differences in the magnetic and electric fields associated with the survey elevation;
d) Splitting said digitized data into a number of equal data segments where each data segment represents a certain geographical location;
e) Optionally detrend the data values for selected variables in said data segments, recording the slopes calculated as part of the detrending analysis, and calculating the RMS values of selected variables in said data segments. A Parzen type filter is used to select specific information of selected frequency bands for further analysis;
f) Deriving the amplitudes of the moduli of the electric and magnetic field strength vectors as well as the angle between these vectors at the selected frequencies as well as other derived function values;
g) Analyzing for the possible presence of an anomalous volume of material, its extent and volume, its depth, as well as an indication of what such anomalous material might be. This analysis includes, but is not limited to, a process of relative comparison of certain function values at certain frequencies to compatible function values of other data segments that include, but are not limited to:
   1) variations in angle between said electric and magnetic field strength vectors;
   2) variations in phase between said electric and magnetic field strength vectors;
   3) variations in amplitudes of said electric and magnetic field strength vectors;
   4) variations in the ratio of said amplitudes of the electric and the magnetic field strength vectors;
   5) variations in certain function values of rational mathematical combinations of said amplitudes of the electric and magnetic field strengths;

More specifically, variations in the angle and phase between the E-type and B-type waves at certain frequencies determine the nature of anomalous volumes of rock at a location.

The depth of the associated geophysical anomalies is derived from differences at selected frequencies between predicted and measured attenuation rates at the various frequencies based on Maxwell's Law.

No corrections to said data are necessary for attitude or heading changes because the resultant of the three orthogonal electric and the three orthogonal magnetic field strength vectors as well as the angle between them are insensitive to attitude or heading changes of the survey device.

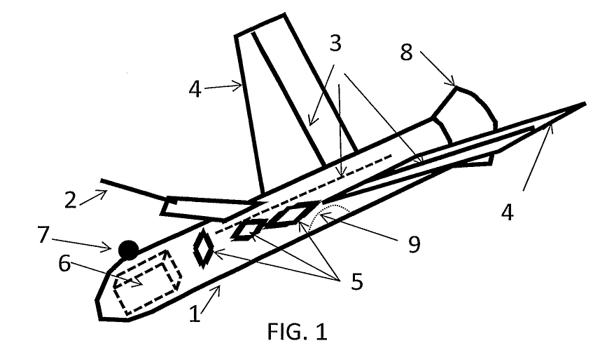

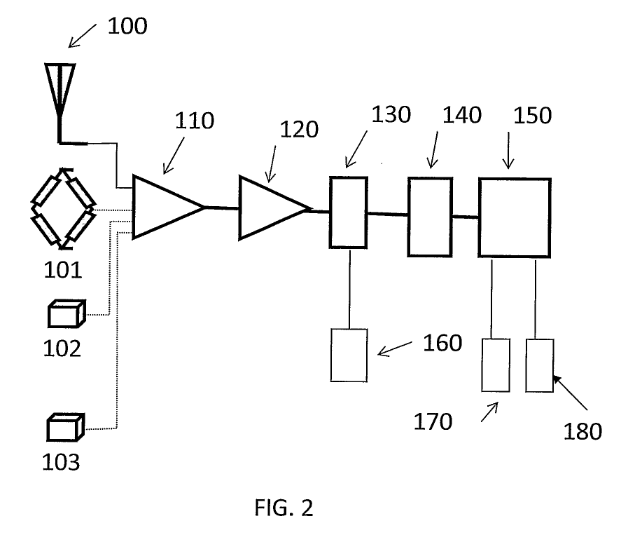

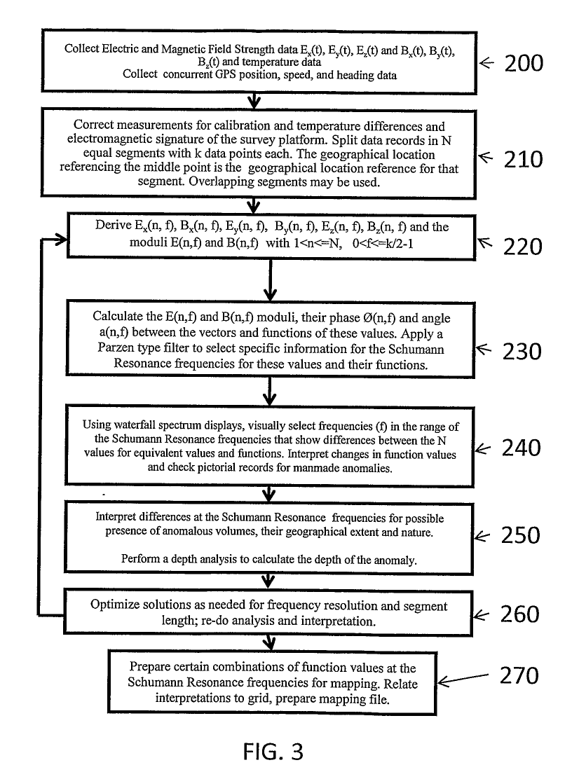

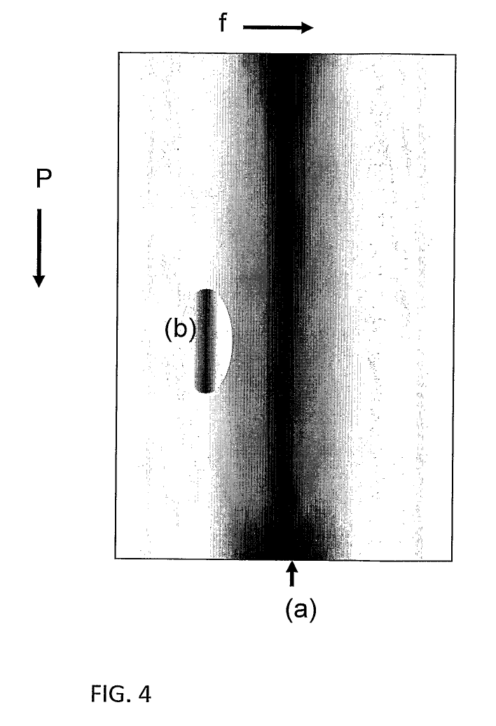

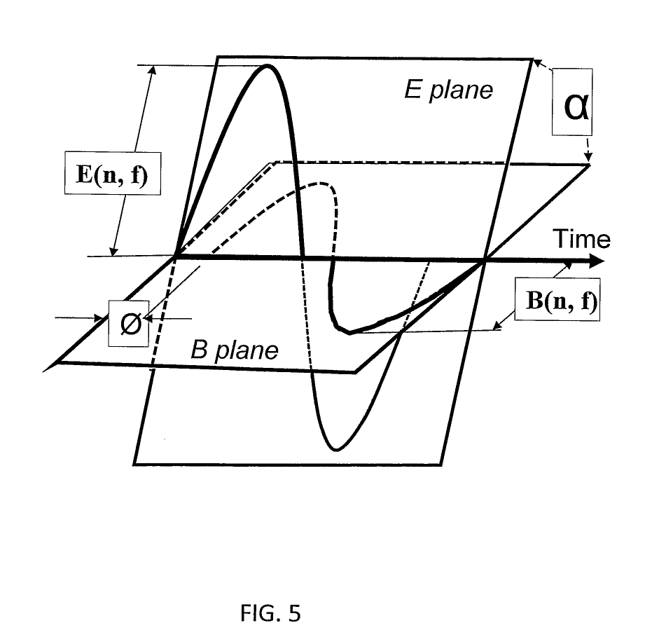

The platform with the sensors illustrated as a towed drone 1 in FIG. 1 may be of different types either included in or attached to an aircraft or possibly on another vessel on sea or land, or consist of a portable device; and, as stated above, the specific nature of the magnetic or electric field antennas or measuring units may vary with the specific situation, but will preferably constitute three independent and mutually orthogonal directions of sensitivity so that the magnitude and relative direction of the field strengths to one another may be found from a combination of the measured signals. According to the preferred embodiment both the electric and magnetic field strength vectors, their variation in frequency content and magnitude, and angle and phase between them can be computed. All of the variables are considered together with the positions of the measurements in locating the anomalies.

Thus, to summarize the invention, it relates to a survey system and a method for locating geophysical anomalies. It includes a moving platform being mounted on or in a drone, airplane, etc. The platform is equipped with a recording unit for recording the position of the platform, three first measuring units or sensors each for measuring the electric field strength E and magnetic field strength B in three independent and preferably mutually orthogonal directions, a temperature measuring unit, a unit providing calibration signals and also a recording unit to record the receiver response to these calibration signals, the measured varying electric field strength, and the magnetic field strength and temperature at chosen time and/or position intervals, thus providing a record of field strengths, temperature and calibration values in time and position. The system includes a calculation unit for combining the measurements from the E- and B-field sensors and calculating and recording the parameters based on these measurements, especially the field strength vectors of the fields at each position as well as certain mathematical functions of the E- and B vectors including, but not limited to, the angle and phase between the E- and B vectors and certain other functions for the chosen frequencies, depending on the situation being from 0.1 Hz and up to 45 Hz (or possibly 300 Hz or 800 Hz for onshore applications). The system according to the invention is also being adapted to compare parameters such as the recorded field strength vectors or related rational mathematical functions of the E- and B field strength vectors so as to detect positions having field strength magnitudes or variations in the magnitudes or mathematical function values that differ from compatible surrounding magnitudes or variations.

According to the preferred embodiment of the invention the survey platform is also equipped with a still camera that records a pictorial view of the area surveyed at regular intervals so as to make it possible at the time of data interpretations to determine if measured anomalies are based on geophysical anomalies or man-made anomalies.

According to the preferred embodiment of the invention, the calculation unit is adapted to modify the measurements for ambient temperature and ambient temperature changes so as to avoid temperature dependent influences on the recorded signals.

According to the preferred embodiment of the invention the calculation unit is adapted to modify the measurements for residual magnetic and electric field strengths of the survey system so as to avoid their influences on the recorded signals.

According to the preferred embodiment of the invention, the calculation unit is adapted to modify the geographical position measurements for the offset that may exist between the location of the E- and B-type measuring devices and the device that measures geographical positions so as to relate the correct geographical positions to the recorded signals.

According to the preferred embodiment the calculation unit is adapted to calculate and record the frequency spectrum of the varying measured field strengths recorded for a certain time interval representative for a certain position as well as calculate and record certain mathematical functions thereof, and calculate and record where the anomalies are located based on relative differences in frequency characteristics of the signal interpretations depending on recording time and representative position. The calculation unit is preferably adapted to extract variations in the electric and/or magnetic field strengths for frequencies, e.g. in the range of 0.1 to 45 Hz as discussed above. Frequencies outside the chosen frequency range may be filtered out using standard filtering techniques as they are considered noise.

In addition both electric and magnetic field strength magnitudes and their variations are recorded and analyzed, so that both are considered when searching for anomalies, thus improving the basis for the anomaly detection. The quality of the data interpretation is further improved by also calculating and considering certain rational mathematical functions thereof such as the angle and phase between the electric and magnetic field vectors as well as other mathematical functions in the interpretation.

The specification above is mainly related to offshore measurements using a chosen frequency range of approximately 0.1 to 45 Hz. The chosen frequency may, however, vary with the depth to which the measurements are intended to reach, the required resolution and/or the conductivity of the material below the surface of the earth in the measured area. Thus for measurements over fresh water or dry land the chosen range may be up to 800 Hz but usually up to 300 Hz.

1. A survey system for locating geophysical anomalies, including a moving platform equipped with a recording unit for recording the position of the platform, the system also comprising three first measuring units, adapted to record a varying electric field strength and a varying magnetic field strength for frequencies in a chosen range at chosen intervals and thus positions, said first measuring units being adapted to measure each said field strength in three directions, the system including a calculation unit for combining the measurements from each of said first sensors and calculating the field strength vectors and recording at least one parameter based on said field strength vectors at each position, the system also being adapted to compare the recorded parameters at different positions and detect positions wherein said parameters differ significantly from the surrounding parameters at other positions.

2. System according to claim 1, wherein the measuring units are adapted to measure each said field strength in three independent mutually orthogonal directions.

3. System according to claim 1, wherein the magnetic sensor has a resolution in the pico Tesla range in each of the three independent mutually orthogonal directions combined with the ability to sample the magnetic field strength with a frequency of several thousand Hertz.

4. System according to claim 1, including an electronic filter adapted to remove signals outside the chosen frequency range.

5. System according to claim 1, wherein said calculation unit is positioned outside the platform, e.g. on a remote base reference station.

6. System according to claim 1, also including a temperature measuring means on said platform and wherein the calculation unit is adapted to modify the measurements for ambient temperature and ambient temperature changes.

7. System according to claim 1, also including a still picture camera that records photographic digital data at regular time intervals and wherein the image recording unit is adapted to store these images together with a time and geographical position tag for the purpose of confirming that no objects are present that could invalidate the interpretation.

8. System according to claim 1, also including means to supply calibration signals to the electronic system to confirm the calibration of the electronic system and if necessary provide the means to update the measurements for a different calibration.

9. System according to claim 1, wherein said parameters also include the frequency spectrum of the varying measured field strength vectors for frequencies in the chosen range.

10. System according to claim 1, wherein said at least one parameter includes both electric and the magnetic field strength measuring units suitable for frequencies in the chosen range, and wherein said calculation unit is adapted to calculate and record magnitudes of both said electric and magnetic field strength vectors for frequencies in that range.

11. System according to claim 1, wherein said at least one parameter also includes the relative directions of both electric and magnetic field strength vectors for frequencies in the chosen range.

12. System according to claim 1, wherein said at least one parameter includes the angle between the electric and magnetic field strength vectors derived from said measurements at each representative position for frequencies in the chosen range.

13. Method for locating geophysical anomalies, including the steps of moving a platform and recording the positions of the platform, and at each position measuring at least one of the magnetic or electric field strengths at said position in three dimensions and calculating and recording at least one parameter derived from the magnitude of said field strengths, and comparing the recorded field strength parameters to detect positions with parameters differing from the compatible surrounding parameters by a certain value at different frequencies in the chosen range.

14. Method according to claim 13, wherein said at least one parameter includes the frequency spectrum of the varying measured field strengths for frequencies in the chosen range at each representative position, said comparison also comparing said frequency spectra.

15. Method according to claim 13, wherein said at least one parameter includes the varying phase and angle between the measured field strength vectors being calculated and recorded at each representative position for frequencies in the chosen range, said comparison also comparing said angles.

16. Method according to claim 13, wherein said at least one parameter includes both calculated magnitudes of the measured electric and magnetic field strength vectors being calculated and recorded at each representative position for frequencies in the chosen range and compared in said comparison for frequencies in the chosen range.

17. Method according to claim 16, wherein said at least one parameter includes the angle between both said field strength vectors being recorded at each representative position and compared in said comparison for frequencies in the chosen range.

18. Method according to claim 16, wherein said at least one parameter includes other rational mathematical functions of both electric and magnetic field strength vector magnitudes calculated at each representative position and compared in said comparison for frequencies in the chosen range.

19. Method according to claim 16, wherein said at least one parameter includes differences in rates of signal attenuation at different frequencies calculated at each representative position and compared in said comparison for frequencies in the chosen range.

20. Method according to claim 16, wherein differences in rates of signal attenuation at different frequencies calculated at each representative position for frequencies in the chosen range are used to compute the depth of the anomalous volume.

21. Method according to claim 15, wherein differences in phases and angles between the E- and B-type vectors at different frequencies calculated at each representative position for frequencies in the chosen range are used to compute the type of the anomalous volume.
